(19) United States
(12) Patent Application Publication
(10) Pub. No.: US 2019/0039552 A1
(43) Pub. Date: Feb. 7, 2019

(54) VEHICLE SEAT ARRANGEMENTS FOR A MOTOR VEHICLE

(71) Applicant: Joyson Safety Systems Germany GmbH, Aschaffenburg (DE)

(72) Inventors: Stefan SCHÄFER, Erbach (DE); Mirko KORTH, Ulm (DE)

(73) Assignee: Joyson Safety Systems Germany GmbH, Aschaffenburg (DE)

(21) Appl. No.: 16/056,186

(22) Filed: Aug. 6, 2018

(30) Foreign Application Priority Data
Aug. 7, 2017 (DE) 10 2017 117 856.2

(51) Int. Cl. B60R 21/207; B60R 21/231

(52) U.S. Cl. CPC B60R 21/207; B60R 21/0132; B60R 21/23138

(57) ABSTRACT

It is provided a vehicle seat arrangement for a motor vehicle, comprising a vehicle seat; an inflatable device which is arranged on the vehicle seat for protecting a vehicle occupant located on the vehicle seat; an inflating means for inflating the inflatable device, wherein the inflatable device has at least one inflatable chamber and is designed and arranged in such a manner that the vehicle occupant receives an impulse by the chamber expanding after the inflating means is triggered. The inflatable device is connected to the vehicle seat via at least two connecting regions of a connecting plane of the vehicle seat in such a manner that, after the triggering of the inflating means, the expansion of the chamber substantially takes place only in a single expansion direction obliquely or perpendicularly to the connecting plane.

### REFERENCE TO RELATED APPLICATION

This application claims priority to German Patent Application No. 10 2017 117 856.2 filed on Aug. 7, 2017, the entirety of which is incorporated by reference herein.

### BACKGROUND

The invention relates to a vehicle seat arrangement for a motor vehicle and to a vehicle seat arrangement.

A vehicle seat arrangement of this type is known, for example, from EP 2 144 787 B1, wherein the inflatable device of said vehicle seat arrangement as part of a pre-crash protection system serves, prior to the beginning of a collision, to exert an impulse on a vehicle occupant located on the vehicle seat, the impulse moving said vehicle occupant into a safer position. The inflatable device has two inflatable elements which, after the triggering, carry out a pivoting movement and move the vehicle occupant away from a collision site of the vehicle. For example, the inflatable device or an inflating means present for inflating the inflatable device is triggered upon a signal of a pre-crash sensor arrangement of the vehicle. However, because the inflatable elements endeavor to undergo a pivoting movement, the connection of the inflatable device to the vehicle seat is complicated and dependent on the design of the vehicle seat.

Furthermore, inflatable elements in the vehicle backrest may, as part of a comfort system, serve to act with a moderate action of force on the occupant independently of a pre-crash or crash signal.

### SUMMARY

A problem to be solved by the invention consists in providing pre-crash protection which can be realized as simply and flexibly as possible and/or of realizing a comfort function which is as readily reversible as possible.

This problem is solved by the provision of the vehicle seat arrangement with features as described herein and the vehicle seat arrangement with features as described herein.

According thereto, a vehicle seat arrangement for a motor vehicle is provided, comprising
a vehicle seat;
an inflatable device which is arranged on the vehicle seat for protecting a vehicle occupant located on the vehicle seat;
an inflating means for inflating the inflatable device, wherein
the inflatable device has at least one inflatable chamber and is designed and arranged in such a manner that the vehicle occupant receives an impulse (in particular away from a collision site or a presumed collision site, for example in the direction of the center of the vehicle seat) by the chamber expanding after triggering of the inflating means, wherein
the inflatable device is connected to the vehicle seat via at least two connecting regions of a connecting plane (a flat connecting surface) of the vehicle seat in such a manner that, after the triggering of the inflating means, the expansion of the chamber substantially takes place only in a single expansion direction obliquely or perpendicularly to the connecting plane.

The inflatable device and the inflating means are in particular components of a pre-crash protection system which has already been mentioned at the beginning and is intended to already bring the vehicle occupant into a safe position in the preliminary stage of a collision. Accordingly, the triggering of the inflating means, which comprises in particular a compressed gas reservoir or a pyrotechnic gas generator, takes place in particular depending on a signal of a pre-crash sensor arrangement (of a pre-crash sensor system) of the vehicle. However, it is also conceivable for the triggering to take place only at the onset of a collision, i.e. depending on a signal of a crash sensor arrangement.

The inflatable device, at least the at least one inflatable chamber thereof, is accommodated, for example, in a lateral region (for example in a side member) of the vehicle seat. In particular, the inflatable device extends below a seat cover and/or a backrest foam of the vehicle seat. It is conceivable for a conventional airbag to be arranged in or on the vehicle seat in addition to the inflatable device.

Owing to the fact that the expansion of the chamber or of the plurality of chambers of the inflatable device substantially takes place in only one direction in space, secure connection of the inflatable device is possible, the connection being adaptable to different designs of the vehicle seat, in particular to different side member architectures and/or different properties of the seat cover or backrest foam. Furthermore, as good a reversibility of the inflating process as possible in particular an effective thickness of the inflatable device in the expansion direction that is as reproducible as possible, can be realized. In order to permit refilling of the chamber (or of the plurality of chambers) after a triggering operation, the chamber can have a venting device (e.g. in the form of a venting opening). The inflatable device can have one venting device per chamber or a common venting device for all of the chambers.

Furthermore, the at least one chamber is in particular designed and connected to the vehicle seat in such a manner that, by means of the filling with gas, essentially only the extent (size) of said chamber in the expansion direction is increased, while its extent perpendicular to the expansion direction remains substantially unchanged. In particular, the chamber is not folded in the non-inflated state and although it is substantially enlarged in the expansion direction by the inflation, the chamber is not deployed. The chamber(s) is or are connected to the connecting surface of the vehicle seat in particular in such a manner that the expansion of the chambers in the expansion direction is restricted as little as possible.

Furthermore, the at least one chamber is in particular designed and connected to the vehicle seat in such a manner that said chamber substantially maintains its orientation in space after the triggering of the inflating means. For example, the connection of the chamber to the vehicle seat is designed in such a manner that a pivoting movement of the chamber is opposed during the inflation, or such a pivoting movement is entirely prevented.

According to another development of the invention, the inflatable device is produced in such a manner that the expansion thereof perpendicular to the expansion direction in the inflated state is not greater than in the non-inflated state. In particular, the area of projection of the inflatable device onto the connecting plane of the vehicle seat in the expansion direction is not increased by the inflation.

The connection of the chamber to the connecting regions is realized, for example, in each case via a fastening element (e.g. in the form of a band or a seam), in an integrally bonded manner (e.g. via an adhesively bonded or welded connection) or via at least one material layer, in particular one or two material layers. The connecting regions are, for example, of circular (e.g. punctiform), linear or flat design (depending, for example on the fastening element used).

The inflatable device of the vehicle seat arrangement according to the invention in particular has at least two inflatable chambers which are adjacent to one another (in particular lie against one another) along the expansion direction, wherein the expansion of the chambers in each case takes place substantially only in the expansion direction after the triggering of the inflating means. A first of the two chambers (the chamber adjacent to the connecting plane of the vehicle seat) is the chamber already explained further above and is correspondingly connected to the connecting regions of the connecting place of the vehicle seat. It is also possible for the inflatable device to have more than two inflatable chambers which are arranged above one another along the expansion direction in the inflated state, with, for example, the adjacent chambers being adjacent to one another (in particular lying against one another). The chambers can be inflated simultaneously or sequentially.

It is conceivable for the second chamber to likewise be connected to the vehicle seat via at least two connecting regions of the connecting plane of the vehicle seat. The position of said connecting regions can differ from the connecting regions via which the first chamber is connected to the connecting plane. However, it is also conceivable for at least some of the connecting regions via which the first chamber is connected to the connecting plane to coincide with connecting regions via which the second chamber is connected to the connecting plane.

Furthermore, the second chamber can be fastened to at least two fastening regions of the first chamber. For example, the second chamber is arranged on a side of the first chamber that faces away from the connecting plane of the vehicle seat, wherein the fastening regions are likewise located, for example, on that side of the first chamber which faces away from the connecting plane. The fastening regions can be configured analogously to the connecting regions via which the first chamber is connected to the connecting plane of the vehicle seat, for example can serve for the integrally bonded fastening or for the fastening of fastening elements, for example in the form of bands, seams or elements, via which the chambers are connected in terms of flow to one another. The fastening regions can be correspondingly likewise of circular (e.g. punctiform), linear or else flat design. Further adjacent chambers of the inflatable device can be connected to one another; e.g. a third chamber to the second chamber, in a similar manner.

It is also possible for the chambers to be connected to one another in such a manner that they substantially maintain their relative position to one another during the inflation. The inflation of the chambers therefore in particular does not result in a shifting of the chambers relative to one another, which would cause an increase in the extent of the inflatable device perpendicularly to the expansion direction. Correspondingly, it is possible for the inflatable device to return as precisely as possible after a triggering into the starting position prior to the inflation, by venting and compression of the chambers (for example under the action of a seat cover and/or a seat foam).

According to a development of the invention, the fastening regions are positioned along a circumference of the first or the second chamber. In particular, the fastening regions are positioned here in such a manner that the length of a connecting line, which runs along the circumference of the first chamber, between the fastening regions, does not exceed half of the circumferential length of the first chamber. For example, the two fastening regions are positioned in such a manner that the length of the connecting line is at maximum. In the event that there are more than two fastening regions, the latter in particular are placed in such a manner that the length of a connecting line, which runs along the circumference of the first chamber (or in general of the adjacent chambers connected via the fastening regions), between adjacent fastening regions does not exceed half of the circumferential length of the first chamber.

However, it is also possible for the fastening regions not to lie on the circumference of the chamber, but rather, for example, to be positioned within the circumference thereof.

The second chamber can also have analogously configured fastening regions, wherein the connection of the chambers to one another takes place via the fastening regions both of the first and of the second chamber. Of course, it is also conceivable for the inflatable device to comprise more than two chambers, wherein at least some of the chambers have the mentioned fastening regions for connection to another chamber (in particular adjacent chamber). For example, the fastening regions are in each case positioned, as explained above with regard to the first chamber, in such a manner that the length of a connecting line, which runs along the circumference of the respective chamber, between the fastening regions does not exceed half of the circumferential length of the chamber.

At least some of the chambers of the inflatable device can have different dimensions (extents) perpendicular to the expansion direction. For example, the chambers are of at least approximately rectangular or elliptical (e.g. circular) design in cross section (perpendicular to the expansion direction), wherein the side lengths or the radii of the chambers (perpendicular to the expansion direction) can differ from one another. Of course, it is also conceivable for the chambers of the inflatable device to have an identical geometry and therefore identical dimensions perpendicular to the expansion direction.

In a second aspect, the invention relates to a vehicle seat arrangement for a motor vehicle, comprising
a vehicle seat;
at least one inflatable device arranged on or in a side member of the vehicle seat;
an inflating means for inflating the inflatable device, wherein
the inflatable device has at least one inflatable chamber and is designed and arranged in such a manner that a vehicle occupant located on the vehicle seat experiences an application of force by the chamber expanding after the activation of the inflating means, and/or the shape and/or size of the side member can be adapted with the aid of the inflatable device, and wherein
the inflatable device has at least two inflatable chambers which are adjacent to one another along the expansion direction,
the inflatable device is connected to the vehicle seat via at least two connecting regions of a connecting plane, in particular of the vehicle seat, in such a manner that, after the activation of the inflating means, the expansion of the chambers in each case substantially takes place only in a single expansion direction obliquely or perpendicularly to the connecting plane, wherein the second chamber is fastened to at least two fastening regions of the first chamber, and wherein the fastening regions are positioned in such a manner that the length of a connecting line, which runs along the circumference of the chamber, between the fastening regions does not exceed half of the length of the circumference of the chamber.

According to the second aspect, the inflatable device is part of a comfort system which, for example, permits adaptation of the side member to the vehicle occupant. The inflatable device is therefore not activated by a pre-crash or crash signal, but rather by a signal (which is in particular triggered by the vehicle occupant) of a comfort means of the vehicle (in particular of the vehicle seat).

It is of course also conceivable for the second chamber (and/or further chambers of the inflatable device) to also have fastening regions positioned analogously to the first chamber, as already explained above.

The invention also relates to a vehicle comprising a vehicle seat arrangement.

### BRIEF DESCRIPTION OF THE DRAWINGS

The invention is explained in more detail below using exemplary embodiments with reference to the figures.

FIG. 1A schematically shows a side view of an inflatable device of a vehicle seat according to the invention, wherein the inflatable chambers of the inflatable device have an ellipsoid configuration.

FIG. 1B shows a modification of FIG. 1A, according to which the chambers of the inflatable device have a rectangular cross section.

FIGS. 2A, 2B show modifications of FIGS. 1A and 1B.

FIGS. 3A, 3B show a further modification of FIGS. 1A, 1B.

FIGS. 4A, 4B show a further modification of FIGS. 1A, 1B.

FIG. 5 shows an illustration for illustrating the positioning of fastening regions between adjacent chambers (rectangular chamber cross section).

FIG. 6 shows an illustration for illustrating fastening regions between adjacent chambers (circular chamber cross section).

FIGS. 7A, 7B show modifications of FIGS. 5 and 6.

FIGS. 8A, 8B show further modifications of FIGS. 5 and 6.

FIGS. 9A, 9B show further modifications of FIGS. 5 and 6.

FIG. 10 shows an illustration of the connection of adjacent chambers to one another.

### DETAILED DESCRIPTION

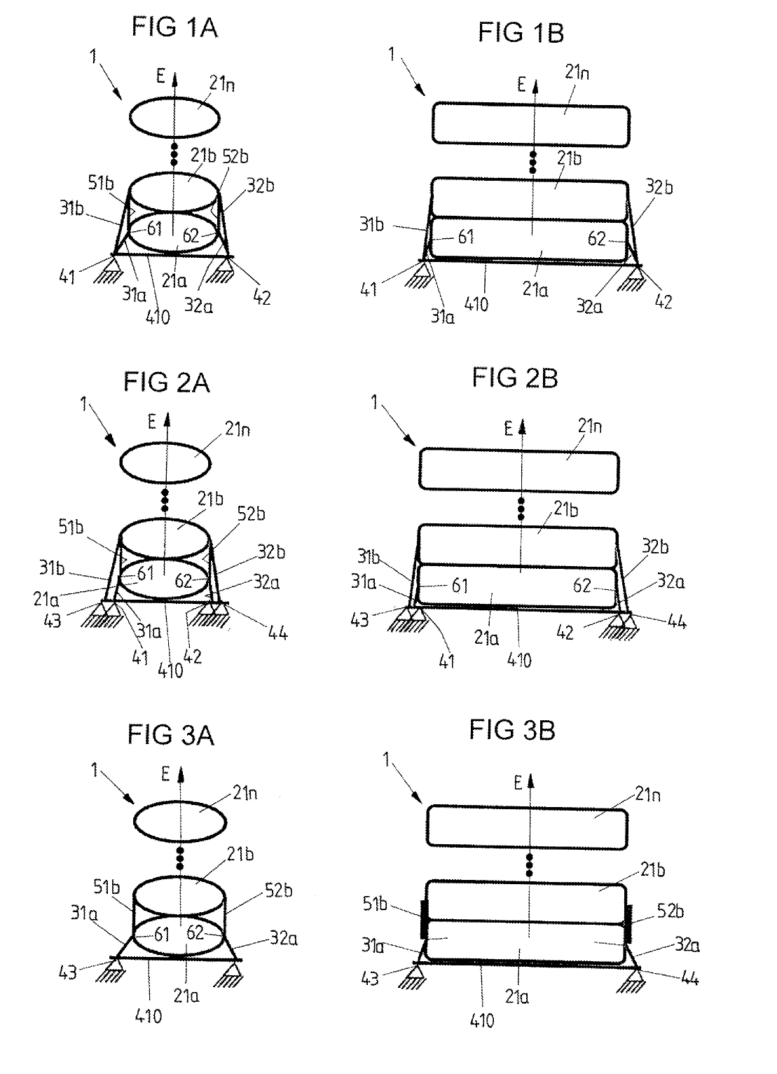

FIG. 1A shows an inflatable device 1 of a vehicle seat according to the invention of a motor vehicle. The inflatable device 1 has a plurality of chambers 21a-21n which are arranged adjacent to one another and one above another in a plurality of planes. The inflatable chambers 21a-n are filled with gas (in particular compressed gas) by an inflating means (not illustrated), wherein, after the inflating means is triggered, the inflated state of the device 1 that is illustrated in FIG. 1A arises. The chambers 21a-n each have a material layer which restricts the inflatable volume of the chambers 21a-n. In the non-inflated state of the chambers 21a-n, an upper and a lower portion of said material layers in each case rest flat on one another.

The inflatable device 1 is part of a pre-crash protection system with which, when an imminent collision of the motor vehicle is detected, an impulse can be exerted on a vehicle occupant located on the vehicle seat by inflation of the chambers 21a-n, said impulse being intended to move said vehicle occupant into a position safer for him/her as far as possible before the beginning of the collision. The chambers 21a-n can be connected to one another via flow connections, via which gas can pass from one chamber into an adjacent chamber. However, it is also conceivable for the chambers 21a-n to be filled in parallel with the aid of the inflating means.

The chambers 21a-n are configured in such a manner that they each have an at least approximately ellipsoid shape in the inflated state. However, it is also conceivable for the chambers 21a-n to each have a different spatial configuration; cf., for example, FIG. 1B.

The lower chamber 21a is connected via at least two connecting elements 31a, 32a (e.g. in the form of bands) to connecting regions 41, 42 of an at least substantially flat connecting surface 410 (mounting surface) of the vehicle seat. The second chamber 21b of the device 1, which chamber is adjacent above and to the first chamber 21a is likewise connected via further connecting elements 31b, 32b to the connecting regions 41, 42 of the connecting surface 410.

In addition, there are fastening elements 51b, 52b (for example, likewise in the form of bands) via which the second inflatable element 21b is connected to the first inflatable element 21a. The remaining chambers 21b-n are in each case also connected to at least one adjacent chamber via further fastening elements (not illustrated). It is also conceivable for the remaining chambers 21b-n to likewise be connected via connecting elements to the connecting regions 41, 42 of the connecting surface 410. However, this is not compulsory.

The chambers 21a-n are designed in such a manner, and the connection of the chambers 21a-n (at least the chambers 21a, 21b) to the connecting surface 410 of the vehicle seat takes place in such a manner, that, after triggering of the inflating means of the device 1, the chambers 21a-n substantially expand only along an expansion direction E oriented obliquely or perpendicular to the connecting surface 410, and the dimensions of said chambers perpendicular to the expansion direction E substantially do not change during the inflation. According to FIG. 1A, the chambers expand along the expansion direction E, but not in a direction perpendicular to the expansion direction E. The abovementioned initiating impulse on the vehicle occupant can thereby be transmitted as efficiently as possible. In addition, the chambers 21a-n are arranged above one another in the expansion direction B in such a manner that the extent of the device 1 perpendicular to the expansion direction E is not increased by the inflation. For example, the chambers 21a-n maintain their relative position to one another.

As already mentioned, the invention is not restricted to a specific geometry of the chambers 21a-n. On the contrary, the chambers 21a-n can have any desired geometry in principle that permits an inflation of the chambers 21a-n substantially only in the expansion direction E. For example, the chambers 21a-n can each have a cuboidal volume, as is shown in FIG. 1B.

The connection of the chambers 21a-n to the connecting surface 410 and/or the fastening of the chambers 21a-n to one another can likewise be configured in diverse ways. It is thus entirely conceivable for the connection of the second chamber 21b (and optionally also at least one of the remaining chambers) to the connecting surface 410 to take place via connecting regions 43, 44 which are positioned at a distance from the connecting regions 41, 42, via which the first chamber 21a is connected to the connecting surface 410. This is illustrated in FIGS. 2A and 2B.

It is also possible for the connection of the inflatable device 1 to the connecting surface 410 to take place by the fact that only the first chamber 21a is connected via the connecting elements 31a, 32a to the connecting regions 41, 42 of the connecting surface 410; cf. FIGS. 3A and 3B.

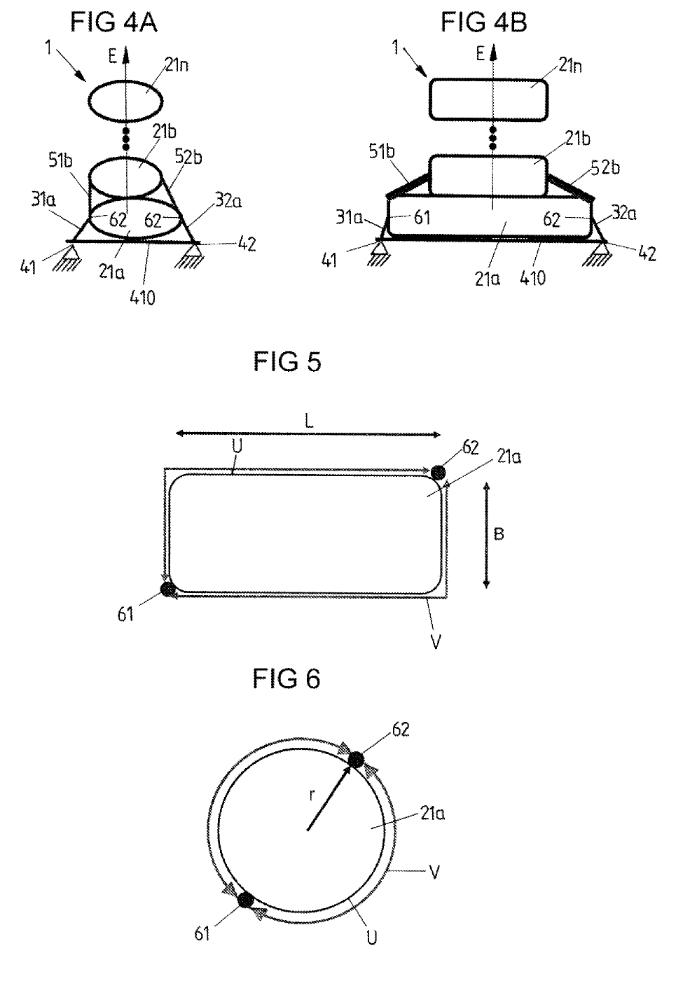

The chambers 21a-n of the inflatable device 1 also do not have to be configured identically. It is thus entirely possible for at least some of the chambers 21a-n to have different geometries and/or sizes. For example, the chambers 21a-n can have different inflatable volumes (FIGS. 4A and 4B). In this connection, the chambers 21a-n can already have different dimensions (e.g. radii or edge lengths) perpendicular to the expansion direction E prior to the inflation.

FIG. 5 schematically shows a cross section of a chamber 21a (for example of the first chamber of FIG. 1B, 2B, 3B or 4B) perpendicular to the expansion direction E. According thereto, the chamber cross section has an approximately rectangular shape with a longer side length L and a shorter side length B. The fastening regions 61, 62, via which the second chamber (not illustrated in FIG. 5) is connected to the first chamber 21a, are positioned in the region of an outer circumference (of the edge) U of the chamber 21a. More precisely, the fastening regions 61, 62 are located in corner regions of the circumference U. A connecting line V which extends along the circumference U between the fastening regions 61, 62 therefore has a length Iᵥ, which at least approximately corresponds to half the circumferential length of the cross section of the chamber 21a.

According to one exemplary embodiment of the invention, the fastening points 61, 62 are in particular placed in such a manner that the connecting line V has a length Iv which corresponds to half the circumference or is smaller than half the circumference of the cross section of the chamber (in the case of more than 2 fastening regions); i.e. Iᵥ≤(L+B).

This principle can be used for chamber circumferences U running in any desired manner, for example for the circular chamber cross section shown in FIG. 6 and for the circumferential line U correspondingly running in the form of a circular line. Accordingly, the connecting line V (which is shown somewhat offset from the circumferential line U for illustrative reasons), which runs on the circumferential line U, between the fastening regions 61, 62 has a length Iᵥ, which corresponds to half the length of the circumferential line U, i.e. has a length of π×r (r: radius of the chamber 21a perpendicular to the expansion direction).

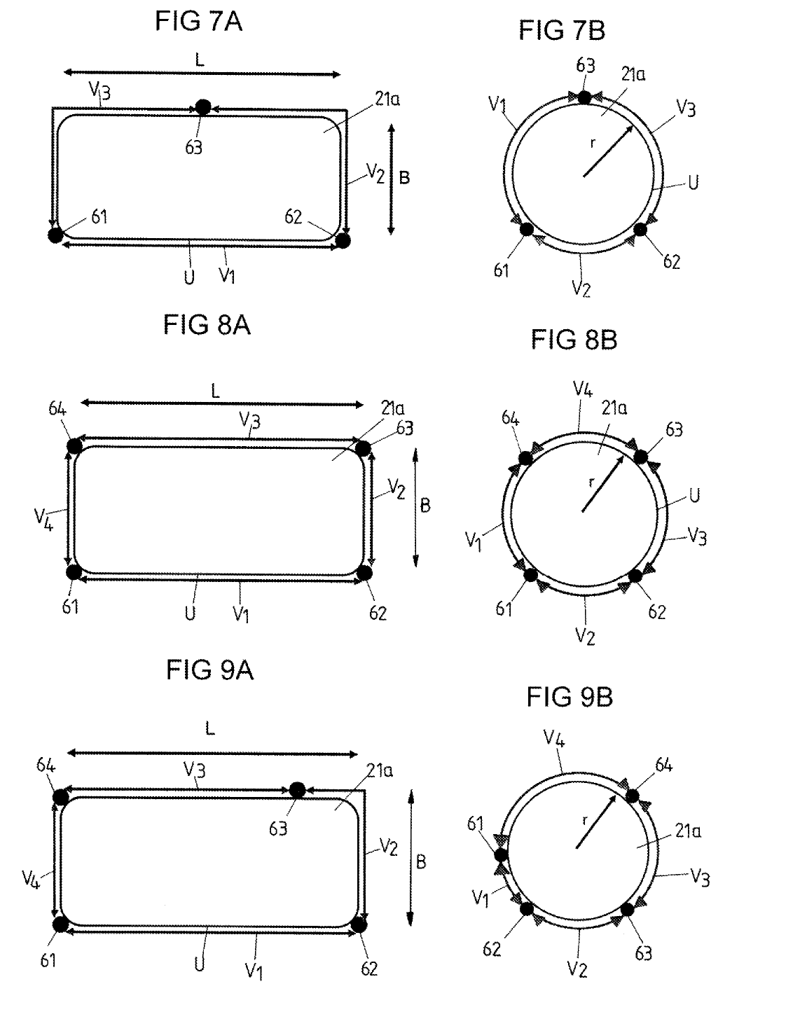

The principle of the positioning of the fastening regions between adjacent chambers is shown for three fastening regions 61-63 in FIG. 7A (rectangular chamber cross section) and FIG. 7B (circular chamber cross section) and four fastening regions 61-64 in FIGS. 8A, 8B and 9A, 9B. The fastening regions are positioned in such a manner that the lengths of the connecting lines V₁, V₂, V₃ and V₄ (FIGS. 8A, 8B, 9A, 9B) which run along the circumferential line U, between adjacent fastening regions are in each case smaller than half the length of the circumferential line U of the inflatable chamber. The lengths of the connecting lines V₁, V₂, V₃ and V₄ may be entirely different.

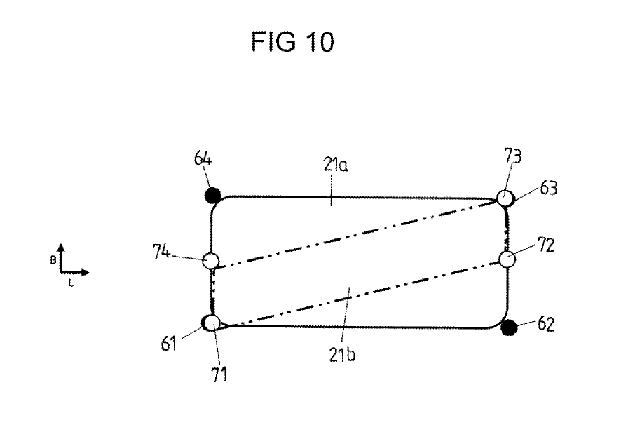

It is shown in FIG. 10 that the fastening of two adjacent chambers 21a, 21b to each other in particular takes place in such a manner that the chambers 21a, 21b are movable relative to each other as little as possible at least in a direction perpendicular to the expansion direction E (cf. FIG. 1A) during the inflation of the chambers. The outline of the first chamber 21a is marked with a solid line, the outline of the second chamber 21b with a chain-dotted line.

For example, the chambers 21a, 21b substantially maintain their relative position to each other perpendicular to the expansion direction. According to FIG. 10, the adjacent chambers 21a, 21b are connected to each other via fastening regions 61-64 of the one chamber 21a and fastening regions 71-74 of the second chamber 21b in such a manner that they are also positioned in the inflated state such that their edge regions substantially coincide. For example, some of the fastening regions are aligned with one another (here the fastening regions 61 and 71 and also 63 and 73). By means of this fastening of the chambers 21a, 21b, in particular none of the inflated chambers 21a, 21b projects beyond the other chamber. The extent of the inflatable device, to which the chambers 21a, 21b belong, perpendicular to the expansion direction is therefore not increased.

It is stressed that elements of the above-described exemplary embodiments may, of course, also be used in combination with one another. The positioning of the fastening regions according to FIGS. 5, 6 and 7A to 9B can thus be used with each of the exemplary embodiments of FIGS. 1A to 4B.

1. A vehicle seat arrangement for a motor vehicle, comprising
a vehicle seat;
an inflatable device which is arranged on the vehicle seat for protecting a vehicle occupant located on the vehicle seat;
an inflating means for inflating the inflatable device, wherein
the inflatable device has at least one inflatable chamber and is designed and arranged in such a manner that the vehicle occupant receives an impulse by the chamber expanding after the inflating means is triggered, and
the inflatable device is connected to the vehicle seat via at least two connecting regions of a connecting plane of the vehicle seat in such a manner that, after the triggering of the inflating means, the expansion of the chamber substantially takes place only in a single expansion direction obliquely or perpendicularly to the connecting plane.

2. The vehicle seat arrangement according to claim 1, wherein the chamber is designed and connected to the vehicle seat in such a manner that, during the expansion of the chamber, essentially only the extent thereof in the expansion direction is increased, while the extent thereof perpendicular to the expansion direction remains substantially unchanged.

3. The vehicle seat arrangement according to claim 1, wherein the chamber is designed and connected to the vehicle seat in such a manner that said chamber substantially maintains its orientation in space after the triggering of the inflating means.

4. The vehicle seat arrangement according to claim 1, wherein the inflatable device is produced in such a manner that the extent thereof perpendicular to the expansion direction in the inflated state is not greater than in the non-inflated state.

5. The vehicle seat arrangement according to claim 1, wherein the connection of the chamber to the connecting regions is realized in each case via a fastening element or in an integrally bonded manner.

6. The vehicle seat arrangement according to claim 1, wherein the inflatable device has at least two inflatable chambers which are adjacent to each other along the expansion direction, wherein the expansion of the chambers in each case takes place substantially only in the expansion direction after the triggering of the inflating means.

7. The vehicle seat arrangement according to claim 1, wherein the inflatable device has more than two inflatable chambers which, in the inflated state, are arranged one above another along the expansion direction, wherein the expansion of the chambers in each case takes place substantially only in the expansion direction after the triggering of the inflating means.

8. The vehicle seat arrangement according to claim 6, wherein a first of the chambers is connected to the vehicle seat via the two connecting regions.

9. The vehicle seat arrangement according to claim 8, wherein the second chamber is likewise connected to the vehicle seat via at least two connecting regions of the connecting plane of the vehicle seat.

10. The vehicle seat arrangement according to claim 8, wherein the second chamber is fastened to at least two fastening regions of the first chamber.

11. The vehicle seat arrangement according to claim 10, wherein the chambers are connected to each other in such a manner that they substantially maintain their relative position to one another during the inflation.

12. The vehicle seat arrangement according to claim 10, wherein the fastening regions are positioned along a circumference of the first chamber.

13. The vehicle seat arrangement according to claim 10, wherein the fastening regions are positioned in such a manner that the length of a connection line, which runs along the circumference of the first chamber, between the fastening regions does not exceed half of the length of the circumference of the first chamber.

14. The vehicle seat arrangement according to claim 6, wherein the chambers have different dimensions perpendicular to the expansion direction.

15. The vehicle seat arrangement according to claim 1, wherein the inflating means can be triggered by a signal of a pre-crash and/or crash sensor system of the vehicle.

16. A vehicle seat arrangement for a motor vehicle, comprising
a vehicle seat;
at least one inflatable device arranged on or in a side member of the vehicle seat,
an inflating means for inflating the inflatable device, wherein
the inflatable device has at least one inflatable chamber and is designed and arranged in such a manner that a vehicle occupant located on the vehicle seat experiences an application of force by the chamber expanding after the activation of the inflating means, and/or the shape and/or size of the side member can be adapted with the aid of the inflatable device, and wherein
the inflatable device has at least two inflatable chambers which are adjacent to one another along the expansion direction, and
the inflatable device is connected to the vehicle seat via at least two connecting regions of a connecting plane in such a manner that, after the activation of the inflating means, the expansion of the chambers in each case substantially takes place only in a single expansion direction obliquely or perpendicularly to the connecting plane, wherein the second chamber is fastened to at least two fastening regions of the first chamber, and wherein the fastening regions are positioned in such a manner that the length of a connecting line, which runs along the circumference of the chamber, between the fastening regions does not exceed half of the length of the circumference of the chamber.

17. A vehicle comprising a vehicle seat arrangement according to claim 1.
